(19) United States
(12) Patent Application Publication
(10) Pub. No.: US 2007/0160752 A1
(43) Pub. Date: Jul. 12, 2007

(54) Process of making carbon-coated lithium metal phosphate powders

(75) Inventor: Zhenhua Mao, Ponca City, OK (US)

Correspondence Address: CONOCOPHILIPS COMPANY, P.O. BOX 2443, BARTLESVILLE, OK, 74004, US

(73) Assignee: ConocoPhillips Company, Houston, TX (US)

(21) Appl. No.: 11/327,972

(22) Filed: Jan. 9, 2006

(51) Int. Cl. B05D 7/00

(52) U.S. Cl. 427/212

(57) ABSTRACT

The present invention provides a process for making uniform carbon-coated LiMPO₄ powders for use as a cathode material in lithium ion batteries. In one embodiment, the process comprises synthesizing a LiMPO₄ powder. The process further comprises coating a carbonaceous coating on to the LiMPO₄ powder to form a coated LiMPO₄ powder. Additionally, the process comprises carbonizing the coated LiMPO₄ powder.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of the Invention

This invention relates generally to the field of making carbon-coated powders. More particularly, this invention relates to making carbon-coated lithium metal phosphate powders.

2. Background of the Invention

Lithium cobalt oxide (LiCoO₂) is currently used as the cathode material for lithium ion batteries. Because LiCoO₂ is expensive, environmentally hazardous, and thermally unstable, the applications of lithium ion batteries are currently limited to portable electronic devices. If an inexpensive and environmentally benign compound can be found to replace LiCoO₂ for lithium ion batteries, lithium ion batteries may become the choice of batteries for many other applications such as power tools and electrical vehicles. Lithium iron phosphate (LiFePO₄) possesses many attractive properties as the cathode material for lithium ion batteries. However, LiFePO₄ is an electronic insulator. To use the material as the cathode material for a lithium ion cathode, a large amount of conductive powder such as graphite or carbon powders is typically used in the cathode. Consequently, the effective energy density of the material may become impractically low. Since the discovery of the material, improving the conductivity of LiFePO₄ powders has been a major subject of research in developing economic cathode materials for lithium ion batteries. Improving such conductivity has been typically addressed by making particles ultra fine, doping other elements into the compound, or blending/coating carbon with the compound. These methods involve time-consuming procedures such as sol-gel processes; accordingly, they might not be cost-effective because additional chemicals such as gelling and chelating agents are consumed in addition to the precursors of the compound itself.

Accordingly, there is a need for an economical process for uniformly coating LiMPO₄ powders with a conductive carbonaceous material. Additional needs include an improved process for making a cathode material for lithium ion batteries.

### BRIEF SUMMARY

These and other needs in the art are addressed in one embodiment by a process for producing a carbon-coated lithium metal phosphate (LiMPO₄) powder. The process comprises providing a LiMPO₄ powder. The process further comprises coating the LiMPO₄ powder with a carbonaceous material to form a coated LiMPO₄ powder. Additionally, the process comprises carbonizing the coated LiMPO₄ powder to produce the carbon-coated lithium metal phosphate powder.

In another embodiment, these and other needs in the art are addressed by a process for coating a LiMPO₄ powder with a carbonaceous material comprising dispersing a lithium metal phosphate powder in a suspension liquid. The process further comprises adding a carbonaceous solution to the LiMPO₄ powder suspension to form a carbonaceous-lithium metal phosphate mixture. In addition, the process comprises heating the carbonaceous-lithium metal phosphate mixture. Moreover, the process comprises reducing the temperature of the carbonaceous-LiMPO₄ mixture to precipitate a carbonaceous material on to the LiMPO₄ powder to form a coated LiMPO₄ powder.

The process for making carbon-coated LiMPO₄ powders overcomes problems in making conventional cathode materials for lithium ion batteries. The process is simple and fast. It does not consume additional chemicals. In addition, the process may coat a carbon film on each LiMPO₄ particle uniformly, which may result in superior performance of the material.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 is a comparison of the 1st cycle potential profiles for the carbon-coated and plain LiFePO₄ powders that were calcined at different temperatures; and

FIG. 2 illustrates the discharge capacity versus cycle number for carbon-coated and plain LiFePO₄ powders that were calcined at different temperatures.

### DETAILED DESCRIPTION OF THE PREFERRED EMBODIMENTS

In an embodiment, carbon-coated LiMPO₄ powders may be prepared by: a) providing a LiMPO₄ powder, b) coating the LiMPO₄ powder with a carbonaceous coating to form coated LiMPO₄ powder, and c) carbonizing the coated LiMPO₄ powder to produce the carbon-coated lithium metal phosphate powder. In an embodiment, the LiMPO₄ powder may be synthesized. The synthesizing of the LiMPO₄ powder may be accomplished using any suitable reaction. In some embodiments, the LiMPO₄ powder may be synthesized via a thermal solid phase reaction with stoichiometric amounts of lithium compounds, metal compounds, and phosphate compounds. Examples of lithium compounds that may be used include, without limitation, lithium hydroxide, lithium carbonate, lithium acetate, lithium oxalate, lithium salts, or combinations thereof. Examples of phosphate compounds that may be used include without limitation, ammonium phosphate, phosphoric acid, lithium phosphate, phosphate salts, or combinations thereof. Additionally, any suitable metal compounds may be used including, without limitation, compounds containing iron (Fe), manganese (Mn), cobalt (Co), nickel (Ni), or any combination thereof. For instance, examples of metal compounds that may be used include without limitation, iron powder, iron oxalate hydrate, metal acetates, metal oxides, metal carbonate, metal salts, or combinations thereof. It is to be understood that the reference “M” in LiMPO₄ represents a first transition metal. The thermal solid phase reaction may be run at any suitable temperatures. For instance, the temperatures may be between about 200° C. and about 1,000° C., alternatively between about 350° C. and about 850° C. The reaction may be carried out in any suitable conditions. For instance, the reaction may be carried out in inert conditions in the absence of oxygen. Without limitation, examples of LiMPO₄ powders that may be synthesized include lithium iron phosphate (LiFePO₄), lithium manganese phosphate (LiMnPO₄), lithium nickel phosphate (LiNiPO₄), or lithium cobalt phosphate (LiCoPO₄), or combinations thereof.

In an embodiment, the particle size of the synthesized LiMPO₄ powder may be controlled to produce a desired particle size. In particular embodiments, the desired particle size of the LiMPO₄ powders is less than about 10 microns, alternatively less than about 1 micron. Without being limited by theory, controlling the particle size involves mechanical mixing, milling, spray-drying or any other suitable chemical method.

The LiMPO₄ powder may be coated with the carbonaceous material by any suitable method. For instance, examples of suitable methods include precipitation. The carbonaceous material may be precipitated on the LiMPO₄ powder by any suitable method to form the coated LiMPO₄ powder. In an embodiment, the coated LiMPO₄ powder may be formed by dispersing the LiMPO₄ powder in a suspension liquid to form a LiMPO₄ powder suspension. A carbonaceous solution may then be added to the LiMPO₄ powder suspension and mixed so that a portion of the carbonaceous material may precipitate on the LiMPO₄ particles in the carbonaceous-LiMPO₄ mixture. The carbonaceous solution may be prepared by dissolving a carbonaceous material in a solvent. The carbonaceous material may comprise a carbon containing compound. Without limitation, examples of carbon containing compounds include petroleum pitches, coal tar pitches, lignin or combinations thereof. In other embodiments, the carbonaceous material may comprise a combination of organic compounds such as acrylonitrile, acrylic compounds, vinyl compounds and/or cellulose compounds. Any suitable solvent may be used to dissolve the carbonaceous material. Without limitation, examples of suitable solvents include xylene, benzene, toluene, or combinations thereof. The solvent may be the same or different than the suspension liquid used to form the LiMPO₄ powder suspension. Without limitation, examples of suitable suspension liquids include xylene, benzene, toluene, or combinations thereof.

Additional embodiments include increasing the temperature of the carbonaceous solution prior to mixing with the LiMPO₄ powder suspension. The carbonaceous solution may be heated to temperatures from about 25° C. to about 400° C., alternatively from about 70° C. to about 300° C. Without being limited by theory, the temperature may be increased to improve the solubility of the carbonaceous material. In an embodiment, the LiMPO₄ powder suspension and/or the carbonaceous solution may be heated before being mixed together. The LiMPO₄ powder suspension and carbonaceous solution may be heated to the same or different temperatures. The LiMPO₄ powder suspension may be heated to temperatures from about 25° C. to about 400° C., alternatively from about 70° C. to about 300° C. In another embodiment, after the LiMPO₄ powder suspension and the carbonaceous solution are mixed together, the carbonaceous-LiMPO₄ mixture may be heated. The carbonaceous-LiMPO₄ mixture may be heated to temperatures from about 25° C. to about 400° C., alternatively from about 70° C. to about 300° C.

The temperature of the carbonaceous-LiMPO₄ mixture may be reduced so that a portion of the carbonaceous material precipitates on the LiMPO₄ powder to form a carbonaceous coating. In particular embodiments, the carbonaceous-LiMPO₄ mixture may be cooled to a temperature between about 0° C. and about 100° C., alternatively between about 20° C. and about 60° C. Once coated, the coated LiMPO₄ powder may be separated from the solution by any suitable method. Examples of suitable methods include filtration, centrifugation, sedimentation, and/or clarification. The amount of carbonaceous material coated on the LiMPO₄ powder may be varied by changing the amount of solvent used to dissolve the carbonaceous material. The amount of solvent used may be any suitable amount to provide a desired coating. In certain embodiments, the weight ratio of carbonaceous material to solvent may be between about 0.1 to about 2, alternatively between about 0.05 and about 0.3, alternatively between about 0.1 and about 0.2. The amount of the carbonaceous material coated on the LiMPO₄ powder may be between about 0.1% and about 20% by weight, alternatively between about 1% and about 10% by weight, and alternatively between about 0.5% and about 6% by weight.

In certain embodiments, the coated LiMPO₄ powder may be dried to remove residual solvent on the coated particles. The coated LiMPO₄ powder may be dried using any suitable method. Without limitation, examples of drying methods include vacuum drying, oven drying, heating, or combinations thereof.

In some embodiments, the coated LiMPO₄ powder may be stabilized after separation. Stabilization may include heating of the coated LiMPO₄ powder for a predetermined amount of time in an inert environment. In an embodiment, the coated LiMPO₄ powder may be subject to heating by raising the temperature to between about 20° C. and 400° C., alternatively between about 250° C. and 400° C., and holding the temperature between about 20° C. and 400° C., alternatively between about 250° C. and about 400° C. for about 1 to about 5 hours In alternative embodiments, the coated LiMPO₄ powder may be heated in the presence of an oxidizing agent. Any suitable oxidizing agent may be used such as a solid oxidizer, a liquid oxidizer, and/or a gaseous oxidizer. For instance, oxygen and/or air may be used as an oxidizing agent. Without being limited by theory, the stabilization step may prevent the coated LiMPO₄ powder particles from fusing.

The coated LiMPO₄ powder may then be carbonized. Carbonization may be accomplished by any suitable method. In an embodiment, the coated LiMPO₄ powder may be carbonized in an inert environment under suitable conditions to carbonize the carbonaceous coating into carbon. Without limitation, suitable conditions include a temperature between about 600° C. and about 1,100° C., alternatively between about 700° C. and about 900° C., and alternatively between about 800° C. and about 900° C. The inert environment may comprise any suitable inert gas including without limitation argon, nitrogen, helium, carbon dioxide, or combinations thereof. Once carbonized, the carbon-coated LiMPO₄ powders may be used as the cathode material in lithium ion batteries or any other suitable use.

To further illustrate various illustrative embodiments of the present invention, the following example is provided.

### EXAMPLE

Synthesis of LiFePO₄—45.86 g of iron oxalate (FeC₂O₄.2H₂O) from Aldrich was dispersed in 58 ml of phosphoric acid solution (containing 29.29 g of 85.4% H₃PO₄), and 10.917 g of lithium hydroxide (LiOH.H₂O, 98%) was dissolved in 20 ml of water which was then gradually poured into the FeC₂O₄+H₃PO₄ solution and thoroughly mixed together. Water was then evaporated under a nitrogen environment at 200° C. The resulting powder was placed in a furnace and heated at 350° C. for 10 hours and then at 450° C. for 20 hours, both in a nitrogen environment. The powder was removed from the furnace, mixed thoroughly, and placed back in the furnace and heated at 650° C. for 20 hours. The resulting powder was LiFePO₄, labeled as A in the following discussion. This powder was milky white and electrically insulating.

Carbonaceous-coating—20 g of the resulting LiFePO₄ were dispersed in 100 ml of 2 wt % pitch-xylene solution and heated to 140° C. In addition, 10 g of petroleum pitch that has about 10% xylene insoluble content was dissolved in 10 g of xylene. The latter was poured into the LiFePO₄ solution while it was continuously stirred. The solution was subsequently heated at 160° C. for 10 minutes and cooled to ambient temperature (−23° C.). The resulting solid particles were separated out by filtration and washed twice with 50 ml of xylene, and then dried under vacuum at 100° C. The resulting dry powder weighed 21.0 g, yielding about 5 wt % of pitch in the powder.

Carbonization—The carbonaceous-coated LiFePO₄ powder was mixed with 5 g of a lithium nitrate solution (containing 0.1 g of LiNO₃), dried and then heated at 260° C. for 2 hours in nitrogen gas. The resulting powder was separated into three samples and they were heated in nitrogen gas at 800, 900, and 950° C. for 2 hours, respectively. The resulting powder remained as loose powder. These samples were labeled as B, C, and D, respectively. The resulting powders were carbon-coated LiFePO₄ because they were black and electrically conductive. For a comparison purpose, 10 g of sample A was also heated at 950° C. for 2 hours. However, after heating, the powder sintered together into a fairly hard chunk. It was then ground in a mortar and pestle. The resulting powder, labeled Sample E, was gray white, and also electrically insulating.

Electrochemical test—Samples A and E were mixed with 8% acetylene carbon black, 4% graphite powders and then mixed with a polyvinylidene fluoride (PVDF) solution to form a slurry. The resulting slurries were cast on an aluminum (Al) foil using a hand doctor-blade coater. The cast films were then dried on a hot plate at 110° C. for 30 minutes. The resulting solid film had a composition of 83% LiFePO₄, 5% PVDF, 8% carbon black and 4% graphite. The films were pressed to a density of about 1.9 g/cc through a hydraulic rolling press.

Samples B, C, and D were similarly fabricated into films as above, but the film compositions were 89% carbon-coated LiFePO₄, 2% carbon black, 4% graphite, and 5% PVDF. The density of the film was also 1.9 g/cc

Disks of 1.65 cm² were punched out from each of the above films and used as the positive electrode in a coin cell for electrochemical tests. The other electrode was lithium metal. A glass matte and a porous polyethylene film (Cellguard® commercially available from Hoechst Celanese Co., Ltd.) were used as the separator between the electrode and Li metal foil. Both the electrodes and separator were soaked with 1 M LiPF₆ electrolyte. The solvent for the electrolyte consisted of 40 wt % ethylene carbonate, 30 wt % diethyl carbonate, and 30 wt % dimethyl carbonate. These cells were charged and discharged under constant currents between 4.0 and 2.5 volt to determine electrochemical properties of the positive electrode material.

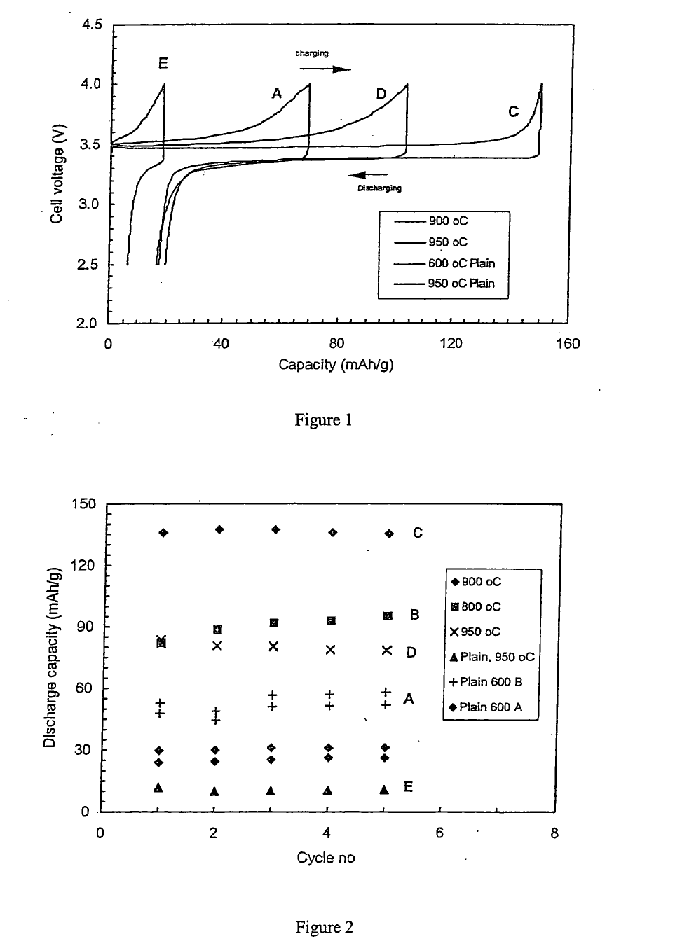

Two of the most important properties were the gravimetric capacity of the positive electrode material and the capacity stability during charging/discharging cycling. FIGS. 1 and 2 show comparisons of these materials as prepared above. FIG. 1 shows a comparison of the electrode potentials as a function of charged and discharged capacity for four materials. For sample A, its electrode potential reached 4.0 volt after a capacity of about 70 mAh/g had been charged into the electrode, but the potential dropped to 2.5 volts after a capacity of about 70 mAh/g had been charged into the electrode. Sample E had a very small charge and discharge capacity (about 10 mAh/g only). However, samples B, C, and D had much better capacity than A, as shown in both FIGS. 1 and 2. For example, sample C had a discharge capacity of about 140 mAh/g.

FIGS. 1 and 2 also show that the carbonization temperature had a significant effect on the carbonaceous-coated LiFePO₄ powders. The preferred carbonization temperature would be between 800 and 900° C. Such prepared carbon-coated LiFePO₄ powders were very stable during charge/discharge cycling. As shown in FIG. 2, the capability of the materials remained constant with cycle number.

Although the present invention and its advantages have been described in detail, it should be understood that various changes, substitutions and alterations may be made herein without departing from the spirit and scope of the invention as defined by the appended claims.

What is claimed is:

1. A process for producing a carbon-coated lithium metal phosphate powder, comprising:
a) providing a lithium metal phosphate powder;
b) coating the lithium metal phosphate powder with a carbonaceous material to form a coated lithium metal phosphate powder; and
c) carbonizing the coated lithium metal phosphate powder to produce the carbon-coated lithium metal phosphate powder.

2. The process of claim 1, wherein the lithium metal phosphate powder comprises lithium iron phosphate, lithium cobalt phosphate, lithium manganese phosphate, lithium nickel phosphate, or combinations thereof.

3. The process of claim 1, wherein step a) comprises synthesizing the lithium metal phosphate powder.

4. The process of claim 1, wherein the lithium metal phosphate powder comprises a particle size less than about 10 microns.

5. The process of claim 1, wherein the carbonaceous material comprises petroleum pitch, coal tar pitch, lignin, or combinations thereof.

6. The process of claim 1, wherein coating the lithium metal phosphate powder further comprises:
a) dispersing the lithium metal phosphate powder in a suspension liquid to form a lithium metal phosphate powder suspension;
b) adding a carbonaceous solution to the lithium metal phosphate powder suspension to form a carbonaceous-lithium metal phosphate mixture; and
c) precipitating carbonaceous material on to the lithium metal phosphate powder to produce the coated lithium metal phosphate powder.

7. The process of claim 6, wherein the carbonaceous solution is prepared by dissolving the carbonaceous material in a solvent.

8. The process of claim 7, wherein the coated lithium metal phosphate powder comprises between about 0.5% and about 20% by weight of the carbonaceous material.

9. The process of claim 6, further comprising heating the carbonaceous solution to a temperature between about 20° C. and about 400° C.

10. The process of claim 6, further comprising heating the lithium metal phosphate powder suspension to a temperature between about 20° C. and about 400° C.

11. The process of claim 6, wherein the carbonaceous solution comprises a weight ratio of carbonaceous material to solvent between about 0.1 and about 2.

12. The process of claim 6, further comprising reducing the temperature of the carbonaceous-lithium metal phosphate mixture to a temperature between about 0° C. and about 100° C.

13. The process of claim 1, further comprising drying the coated lithium metal phosphate powder.

14. The process of claim 1, further comprising stabilizing the coated lithium metal phosphate powder at a temperature between about 20° C. and 400° C.

15. The process of claim 1, wherein carbonizing the coated lithium metal phosphate powder comprises carbonization at a temperature between about 600° C. and about 1,100° C.

16. The process of claim 1, wherein carbonizing the coated lithium metal powder is accomplished in the presence of an inert gas.

17. A process for coating a lithium metal phosphate powder with a carbonaceous material comprising:
a) dispersing the lithium metal phosphate powder in a suspension liquid to form a lithium metal phosphate powder suspension;
b) adding a carbonaceous solution to the lithium metal phosphate powder suspension to form a carbonaceous-lithium metal phosphate mixture;
c) heating the carbonaceous-lithium metal phosphate mixture; and
d) reducing the temperature of the carbonaceous-lithium metal phosphate mixture to precipitate a carbonaceous material on to the lithium metal phosphate powder to form a coated lithium metal phosphate powder.

18. The process of claim 17, wherein the carbonaceous solution is prepared by dissolving the carbonaceous material in a solvent.

19. The process of claim 17, wherein the carbonaceous material comprises petroleum pitch, coal tar pitch, lignin or combinations thereof.

20. The process of claim 17, wherein the coated lithium metal phosphate powder comprises between about 0.5% and about 20% by weight of the carbonaceous material.

21. The process of claim 17, further comprising heating the carbonaceous solution to a temperature between about 20° C. and about 400° C.

22. The process of claim 17, wherein the carbonaceous solution comprises a weight ratio of carbonaceous material to solvent between about 0.1 and about 2.

23. The process of claim 17, further comprising reducing the temperature of the carbonaceous-lithium metal phosphate mixture to a temperature between about 0° C. and about 100° C.

24. The process of claim 17, further comprising drying the coated lithium metal phosphate powder.

25. The process of claim 17, further comprising stabilizing the coated lithium metal phosphate powder at a temperature between about 20° C. and 400° C.
